(19) United States
(12) Patent Application Publication
(10) Pub. No.: US 2025/0333284 A1
(43) Pub. Date: Oct. 30, 2025

(54) TOOL WITH INTERCHANGEABLE HEADS

(71) Applicant: Hong Ann Tool Industries Co., Ltd., Taichung City (TW)

(72) Inventor: Cheng-Wei SU, Taichung City (TW)

(21) Appl. No.: 19/098,520

(22) Filed: Apr. 2, 2025

(30) Foreign Application Priority Data
Apr. 30, 2024 (TW) 113116179

(51) Int. Cl. B66F 15/00; B25G 3/18; B25G 3/38

(52) U.S. Cl. CPC B66F 15/00; B25G 3/18; B25G 3/38

(57) ABSTRACT

A tool with interchangeable heads includes a lever with a pivoting head and a slot configured to receive multiple tool heads. The tool heads are secured via an engaging mechanism using an elastically biased engaging member, allowing quick and tool-free attachment and removal. The first tool head features dual pry forks with a central groove for prying operations. The second tool head has a modified pry fork configuration for expanded utility. The third tool head incorporates a fixed and a movable toothed head enabling gripping and clamping functions. The tool enhances efficiency, durability, and user convenience across various applications.

### BACKGROUND OF THE INVENTION

The present invention relates to hand tools, and more particularly, to a hand tool with interchangeable working heads.

Taiwan Patent No. M647545 discloses a hand tool that comprises a connecting rod, a sleeve with a non-circular recessed portion, and a hole passing through the sleeve wall connecting to the recessed portion. A fastener engages the hole and extends into the recessed portion. The tool also comprises a pry bar assembly with multiple pry heads of different functional shapes and connecting rods. Each rod is connected to a pry head and has an insertion end with a narrower neck portion and a groove around the neck portion. The insertion end faces the recessed portion, allowing the rod to be inserted and preventing rotation relative to the sleeve. The fastener enters the groove at the neck portion, blocking the rod.

However, the tool requires external tools for head replacement, introducing unnecessary complexity. The reliance on additional tools and complicated fastening mechanisms reduces the tool's convenience and efficiency. It also suffers from cumbersome head replacement procedures, insecure locking mechanisms, and limited versatility, hindering its effectiveness for various tasks.

The present invention is, therefore, intended to obviate or at least alleviate the problems encountered in the prior art.

### SUMMARY OF THE INVENTION

The present invention provides a tool with interchangeable heads comprising a lever and different tool heads—first, second, and third—that can be selectively attached to the lever. The tool comprises a lever with a pivoting head and a slot configured for receiving different tool heads. Each tool head includes an engaging mechanism using an elastically-biased engaging member. The first and second tool heads function as pry heads. The third tool head incorporates a fixed and a movable toothed head.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept upon which this disclosure is based may readily be utilized as a basis for designing other structures, methods, and systems for carrying out the several purposes of the invention. It is important, therefore, that the claims be regarded as including such equivalent constructions insofar as they do not deviate from the spirit and scope of the invention.

Furthermore, the purpose of the abstract is to enable the general public, particularly scientists, engineers, and practitioners in the field who may not be familiar with patent or legal terminology, to quickly determine the nature and essence of the technical information through a brief examination. The abstract is not meant to define the invention, which is determined by the claims, nor is it intended to limit the scope of the invention in any manner.

Other objectives, advantages, and new features of the invention will become apparent from the following detailed description of the invention when considered in conjunction with the accompanied drawings.

### BRIEF DESCRIPTION OF DRAWINGS

FIG. 1 is a perspective view of a tool with interchangeable heads combined with a first tool head according to the present invention.

FIG. 2 is an exploded perspective view of the tool of FIG. 1.

FIG. 3 is a cross-sectional view of the tool of FIG. 1.

FIG. 4 is an operational view showing the detachment of a first tool head of the tool of FIG. 1.

FIG. 5 is an exploded perspective view showing the tool of FIG. 1 combined with a second tool head according to the present invention.

FIG. 6 is a cross-sectional view showing the tool of FIG. 1 combined with the second tool head.

FIG. 7 is a perspective view showing the tool of FIG. 1 combined with a third tool head according to the present invention.

FIG. 8 is an exploded perspective view showing the tool of FIG. 1 combined with the third tool head.

FIG. 9 is a cross-sectional view showing the tool of FIG. 1 combined with the third tool head.

### DETAILED DESCRIPTION OF THE INVENTION

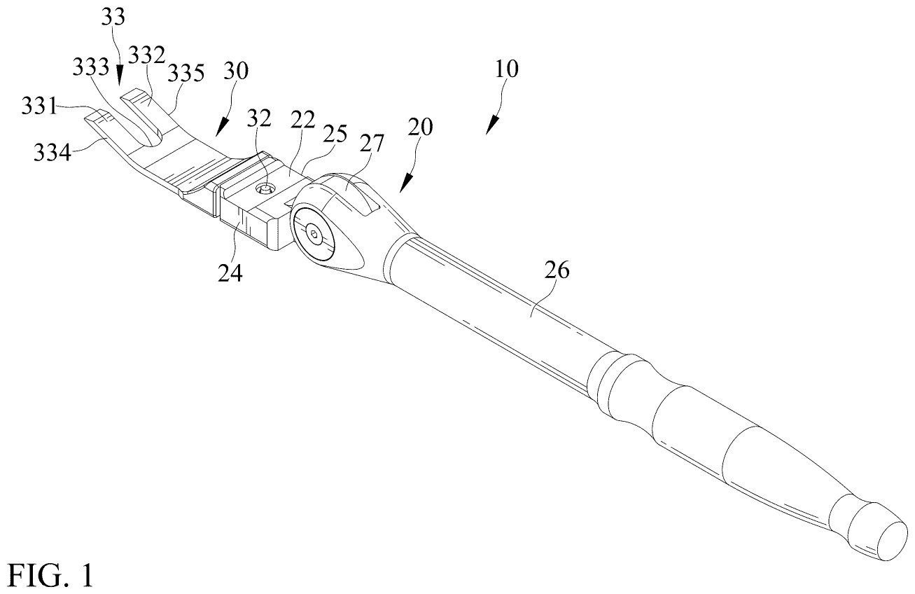

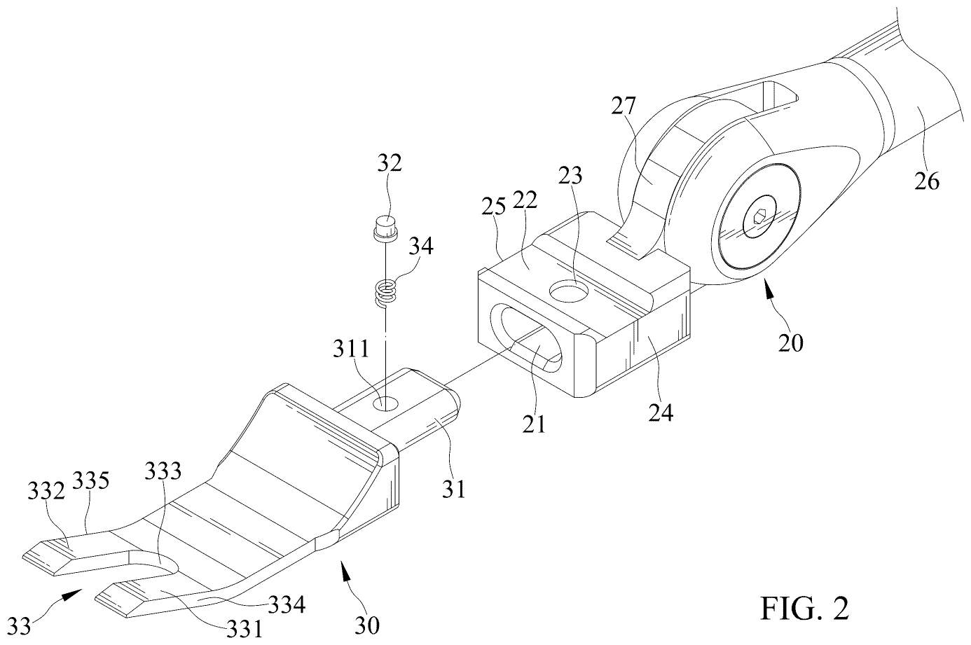

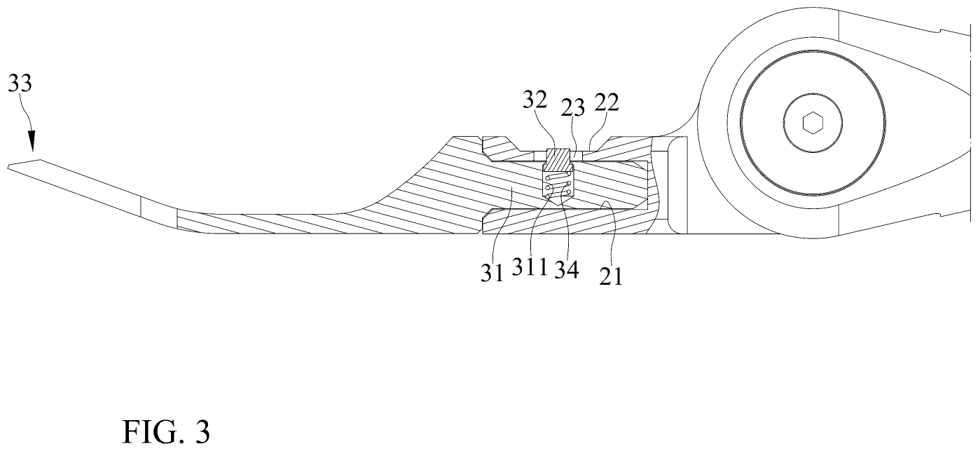

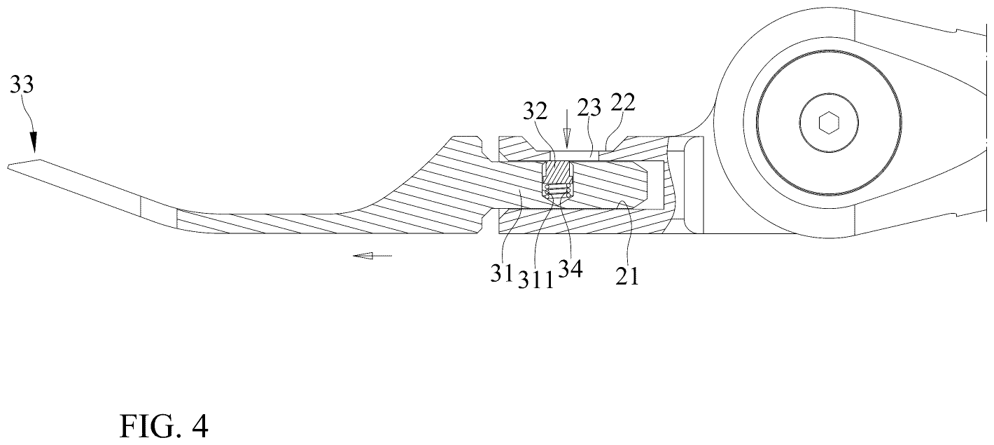

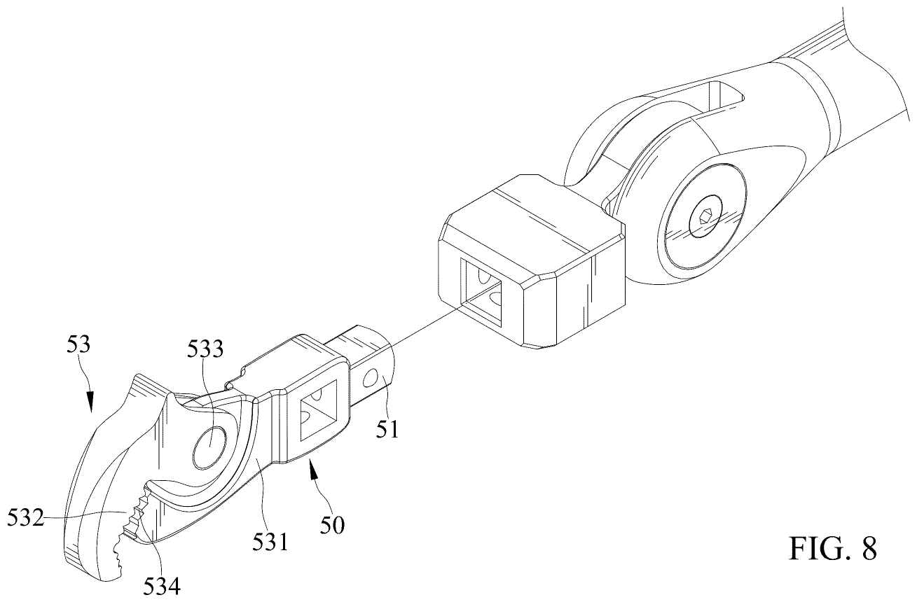

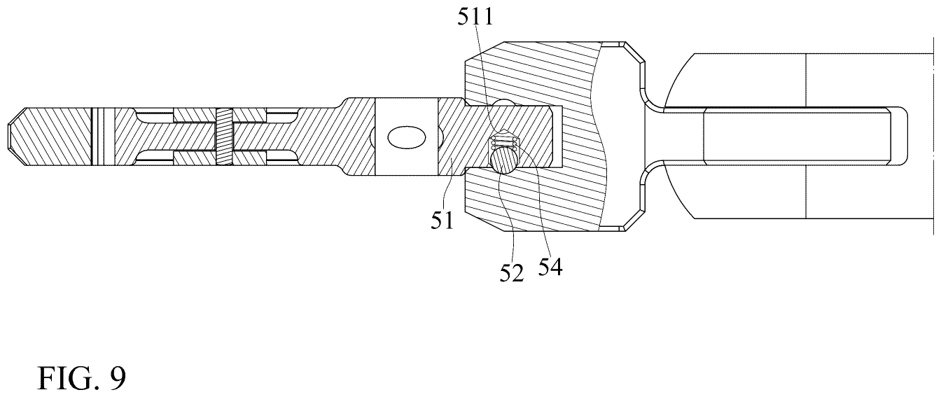

Referring to FIGS. 1-9, a tool 10 in accordance with the present invention comprises a lever 20 and either a first tool head 30, a second tool head 40, or a third tool head 50 removably engageable with the lever 20.

The lever 20 is provided with a slot 21. The lever 20 has a top portion 22 along its vertical edge. The lever 20 includes an engaging hole 23 connecting the slot 21. The lever 20 forms a first side 24 and a second side 25 opposite to the first side 24 along the radial left and right sides of the slot 21. The first and the second sides 24 and 25 define a width of the pivoting head 27. The lever 20 includes a handle 26 and a pivoting head 27. The pivoting head 27 pivotally connects to the handle 26 and swings relative to the handle 26. The slot 21, the top portion 22, the first side 24, and the second side 25 are all arranged on the pivoting head 27. The pivoting head 27 is rotatable to at least a first angle and a second angle relative to the handle 26.

Referring to FIGS. 1-4, the first tool head 30 has a first connecting portion 31 at one end. The first connecting portion 31 includes a first recess 311 on its outer periphery containing a first engaging member 32. The first engaging member 32 can selectively retract into or protrude from the first recess 311. The first tool head 30 includes a first working portion 33 at the end opposite to the first connecting portion 31. The first working portion 33 is configured as a pry head. The first working portion 33 includes a first pry fork 331 and a second pry fork 332, with a first groove 333 set between the first pry fork 331 and the second pry fork 332. The first pry fork 331 has a first edge 334 on a side opposite to the first groove 333. The second pry fork 332 has a second edge 335 on a side opposite to the first groove 333. The distance between the first edge 334 and second edge 335 is not greater than the distance between the first side 24 and second side 25. The first recess 311 is provided with a first biasing member 34. One end of the first biasing member 34 abuts against the inner periphery of the first recess 311, and another end abuts against the first engaging member 32. The first biasing member 34 pushes the first engaging member 32 to protrude from the first recess 311. The first engaging member 32 has a wide end retained in the first recess 311 and a narrow end that selectively retracts into or protrudes from the first recess 311.

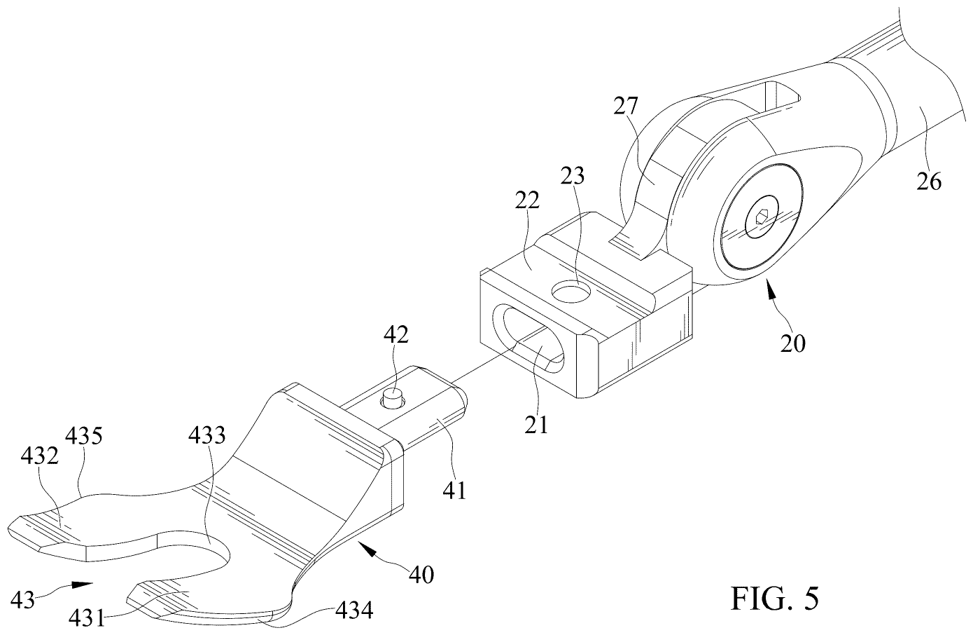

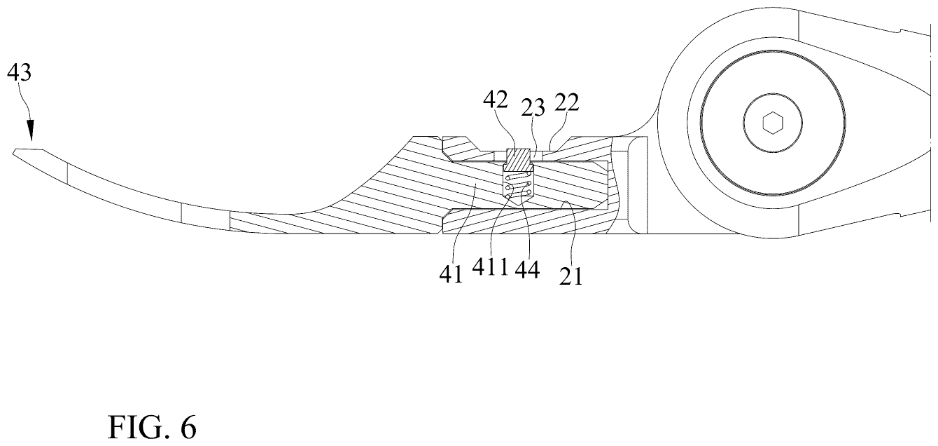

Referring to FIGS. 5 and 6, the second tool head 40 has a second connecting portion 41 at one end. The second connecting portion 41 includes a second recess 411 on its outer periphery containing a second engaging member 42. The second engaging member 42 can selectively retract into or protrude from the second recess 411. The second tool head 40 has a second working portion 43 at an end opposite to the second connecting portion 41. The second working portion 43 is configured as a pry head. The second working portion 43 includes a third pry fork 431 and a fourth pry fork 432, with a second groove 433 set between the third pry fork 431 and the fourth pry fork 432. The third pry fork 431 has a third edge 434 on a side opposite to the second groove 433. The fourth pry fork 432 has a fourth edge 435 on a side opposite to the second groove 433. The distance between the third edge 434 and fourth edge 435 is greater than the distance between the first side 24 and second side 25. The second recess 411 is provided with a second biasing member 44. One end of the second biasing member 44 abuts against the inner periphery of the second recess 411, and the other end abuts against the second engaging member 42. The second biasing member 44 can push the second engaging member 42 to protrude from the second recess 411. The second engaging member 42 has a wide end retained in the second recess 411 and a narrow end that selectively retracts into or protrudes from the second recess 411.

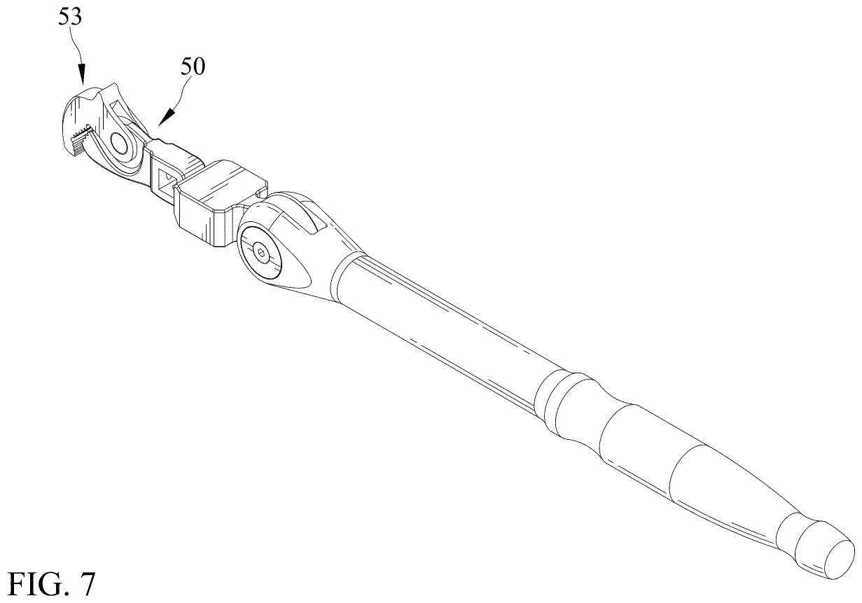

Referring to FIGS. 7-9, the third tool head 50 includes a third connecting portion 51 at one end. The third connecting portion 51 includes a third recess 511 on its outer periphery containing a third engaging member 52. The third engaging member 52 can selectively retract into or protrude from the third recess 511. The third recess 511 is provided with a third biasing member 54. One end of the third biasing member 54 abuts against the inner periphery of the third recess 511, and the other end abuts against the third engaging member 52. The third biasing member 54 can push the third engaging member 52 to protrude from the third recess 511. The engaging member 52 is in a form of a sphere.

The third tool head 50 further includes a third working portion 53 located at an end opposite to the third connecting portion 51. The third working portion 53 comprises a fixed toothed head 531 and a movable toothed head 532. The movable toothed head 532 is pivotally connected to the fixed toothed head 531 via a pivot 533, allowing rotational movement about the pivot axis. The movable toothed head 532 is angled relative to the fixed toothed head 531 and features a curved profile that tapers toward its gripping edge 534. This shape enhances precision and ensures that the third tool head 50 can securely engage objects with varying geometries.

In view of the foregoing, the tool 10 can provide tool head replacement functionality through the above structure. Additionally, the tool 10 allows for easy adaptation to various applications by enabling the interchangeability of tool heads 30, 40, and 50 for different functions. The secure engaging mechanism ensures that the tool heads 30, 40, and 50 remain firmly attached during use while allowing quick release when replacement is required. The use of biasing members 34, 44, and 54 to bias the engaging members 32, 42, and 52 into the recesses 311, 411, and 511 provides a robust locking mechanism without requiring external tools for installation or removal.

Furthermore, the incorporation of a pivoting head 27 enhances maneuverability, allowing users to adjust the tool head angle for better ergonomics and increased efficiency in constrained workspaces. This design also reduces user fatigue by allowing ergonomic positioning during operation.

Although specific embodiments have been illustrated and described, numerous modifications and variations are still possible without departing from the scope of the invention. The scope of the invention is limited by the accompanying claims.

1. A tool with interchangeable tool head comprising:
a lever, wherein the lever includes a handle and a pivoting head rotatably connected to the handle, and wherein the pivoting head defines a slot extending inwardly from an edge of the pivoting head configured for self-alignment of tool heads, a top portion along the edge, an engaging hole connecting the slot, a first side along a radial left side of the slot, and a second side along a radial right side of the slot opposite to the first side; and
a plurality of interchangeable tool heads, each tool head comprising:
a connecting portion at one end, wherein the connecting portion includes a recess on its outer periphery and is shaped to fit within the slot to attain stable engagement;
an engaging member disposed in the recess, wherein the engaging member is configured to selectively retract into or protrude from the recess;
a biasing member disposed in the recess, wherein one end of the biasing member abuts against an inner periphery of the recess and another end abuts against the engaging member; and
a working portion at an opposite end from the connecting portion;
wherein the connecting portion of each tool head is configured to be removably inserted into the slot of the pivoting head such that the engaging member engages with the engaging hole to removably secure the tool head to the pivoting head.

2. The tool with interchangeable tool heads as claimed in claim 1, wherein a first tool head of the plurality of interchangeable tool heads comprises a first working portion configured as a pry head, wherein the first working portion includes a first pry fork, a second pry fork, and a first groove set between the first pry fork and the second pry fork, and wherein the first pry fork has a first edge on a side opposite to the first groove, the second pry fork has a second edge on a side opposite to the first groove, and a distance between the first edge and the second edge is not greater than a distance between the first side and the second side of the pivoting head.

3. The tool with interchangeable tool heads as claimed in claim 1, wherein a second tool head of the plurality of interchangeable tool heads comprises a second working portion configured as a pry head, wherein the second working portion includes a third pry fork, a fourth pry fork, and a second groove set between the third pry fork and the fourth pry fork, and wherein the third pry fork has a third edge on a side opposite to the second groove, the fourth pry fork has a fourth edge on a side opposite to the second groove, and a distance between the third edge and the fourth edge is greater than the distance between the first side and the second side of the pivoting head.

4. The tool with interchangeable tool head as claimed in claim 1, wherein a third tool head of the plurality of interchangeable tool heads comprises a third working portion, and wherein the third working portion includes a fixed toothed head and a movable toothed head pivotally connected to the fixed toothed head.

5. The tool with interchangeable tool head as claimed in claim 4, wherein the movable toothed head is angled relative to the fixed toothed head and features a curved profile that tapers toward a gripping edge.

6. The tool with interchangeable tool head as claimed in claim 1, wherein the connecting portion of each tool head is dimensioned to fit within the slot such that, when inserted, the tool head is aligned with a longitudinal axis of the pivoting head.

7. The tool with interchangeable tool head as claimed in claim 1, wherein the engaging members of each tool head has a wide end retained in the respective recess and a narrow end that selectively retracts into or protrudes from the respective recess.

8. The tool with interchangeable tool head as claimed in claim 1, wherein the engaging member of each tool head is in a form of a sphere.

9. A tool with interchangeable tool head comprising:
a lever, wherein the lever includes a handle and a pivoting head rotatably connected to the handle, wherein the pivoting head defines a slot extending inwardly from an edge of the pivoting head configured for self-alignment of tool heads, a top portion along the edge, an engaging hole connecting the slot, a first side along a radial left side of the slot, and a second side along a radial right side of the slot opposite to the first side, and wherein the first and the second sides define a width of the pivoting head; and
a plurality of interchangeable tool heads, each tool head comprising:
a connecting portion at one end, wherein the connecting portion includes a recess on its outer periphery and is shaped to fit within the slot to attain stable engagement;
an engaging member disposed in the recess, wherein the engaging member is configured to selectively retract into or protrude from the recess;
a biasing member disposed in the recess, wherein one end of the biasing member abuts against an inner periphery of the recess and another end abuts against the engaging member; and
a working portion at an opposite end from the connecting portion;
wherein the connecting portion of each tool head is configured to be removably inserted into the slot of the pivoting head such that the engaging member engages with the engaging hole to removably secure the tool head to the pivoting head;
wherein the first working portion includes a first pry fork and a second pry fork, and a first groove between the first and the second pry forks, and wherein the first pry fork has a first edge and the second pry fork has a second edge defining a width less than the width of the pivoting head; and
wherein the second working portion includes a third pry fork and a fourth pry fork, and a second groove between the third and the fourth pry forks, and wherein the third pry fork has a third edge and the fourth pry fork has a fourth edge defining a width greater than the width of the pivoting head; and
wherein the third working portion includes a fixed toothed head and a movable toothed head pivotally connected to the fixed toothed head.

10. The tool with interchangeable tool head as claimed in claim 9, wherein the connecting portion of each tool head is dimensioned to fit within the slot such that, when inserted, the tool head is aligned with a longitudinal axis of the pivoting head.

11. The tool with interchangeable tool head as claimed in claim 9, wherein the engaging members of each tool head has a wide end retained in the respective recess and a narrow end that selectively retracts into or protrudes from the respective recess.

12. The tool with interchangeable tool head as claimed in claim 9, wherein the engaging member of each tool head is in a form of a sphere.

13. The tool with interchangeable tool head as claimed in claim 9, wherein the movable toothed head is angled relative to the fixed toothed head and features a curved profile that tapers toward a gripping edge.
